(19) United States
(12) Patent Application Publication
(10) Pub. No.: US 2010/0020928 A1
(43) Pub. Date: Jan. 28, 2010

(54) MEDICAL 3D X-RAY IMAGING DEVICE WITH A ROTATING C-SHAPED ARM

(75) Inventor: Peter Van De Haar, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/722,201

(22) PCT Filed: Dec. 22, 2005
(86) PCT No.: PCT/IB05/54384

§ 371 Date: Jun. 20, 2007

(30) Foreign Application Priority Data
Dec. 28, 2004 (EP) 04107017.8

(51) Int. Cl. G01N 23/04

(52) U.S. Cl. 378/62

(57) ABSTRACT

A medical three-dimensional X-ray imaging device comprising a C-shaped arm (14) that can revolve around an axis of rotation through an object (7) to be imaged. An X-ray source (17) is attached to one end of the C-shaped arm (14), and an X-ray detector (18) for receiving X-rays is attached to the other end of the C-shaped arm (14). An attenuator (20) is present in front of the X-ray source (17), which attenuator (20) absorbs a portion of the X-rays. The degree of absorption in the central part of the attenuator (20) is lower than the degree of absorption in the part of the attenuator (20) surrounding said central part.

The invention is related to a medical three-dimensional (3D) X-ray imaging device comprising an arm that can revolve around an axis of rotation through an object to be imaged, whereby an X-ray source is attached to one end of the arm, and whereby an X-ray detector for receiving X-rays is attached to the other end of the arm.

Such medical device is disclosed in WO98/24368, which publication describes a device for making tomographic images, i.e. three-dimensional images. An arm, which is preferably implemented as a C-shaped arm, can make revolving motions around different axes of rotation, whereby the object to be imaged is located at a fixed location between the two ends of the C-shaped arm. The revolving motion whereby the axis of rotation is located in the plane of the C-shaped arm and passes the C-shaped arm through its central part, is called a propeller motion. The revolving motion whereby the axis of rotation is positioned perpendicular to the plane of the C-shaped arm and which axis passes that plane between the two ends of the C-shaped arm, is called a circular rotation. In general, also other revolving motions around other axes of rotation are possible.

The X-ray source at one end of the C-shaped arm emits X-rays, which X-rays are directed towards the object (for example the body of a patient). A portion of the X-rays is absorbed in the material of the object, and the remainder of the X-rays are received by the X-ray detector at the other end of the C-shaped arm, whereby the X-ray detector comprises an image intensifier in order to intensify the signals. Because of the rotation of the C-arm, the X-rays hit the object from varying directions, whereby the information which is contained in several images of the same part of the object taken from different directions can be reconstructed into a 3D image showing the interior of the object. In case the C-arm rotates over an angle of some more than 180°, a 3D image having a good quality can be reconstructed by the device.

A portion of the X-rays that is emitted by the X-ray source is received by the X-ray detector, and another portion of the emitted X-rays is absorbed in the object to be imaged. Thereby, the degree of absorption depends on the physical properties of the different materials in the object, and it depends on the length of the path of the X-rays through the object. Often, a portion of the X-rays that is received by the X-ray detector has not passed the object to be imaged, in particular X-rays in the fringe area of the X-ray beam.

The X-ray detector may comprise an X-ray image intensifier or may be a flat panel X-ray detector. In both cases there may occur a phenomenon called low frequency drop (LFD), also called flare, or veiling glare, which phenomenon may enhance semi-circular artifacts in particular in medium-contrast and low-contrast 3D image reconstructions. In case of medium-contrast and soft-tissue 3D imaging, these artifacts may result in an unacceptable reduction of the contrast resolution.

The phenomenon called flare (low frequency drop) is described in the publication “Origins of flare in X-ray image intensifiers” by R. Luhta and J. A. Rowlands in Medical Physics, Vol. 17, No. 5, September/October 1990, pages 913-921. This publication describes that flare can be caused by scattering of X-rays, by scattering of electrons, and by scattering or reflection of light in the image intensifier.

An object of the invention is to provide a three-dimensional (3D) X-ray imaging device comprising an arm, whereby an X-ray source is attached to one end of the arm, and whereby an X-ray detector is attached to the other end of the arm, whereby disturbances of the produced 3D reconstruction caused by low frequency drop in the image intensifier are reduced, so that the quality of the reconstructed 3D image is improved.

To accomplish with that object, an attenuator is present in front of the X-ray source, which attenuator absorbs a portion of the X-rays in such a manner that the degree of absorption in the central part of the attenuator is lower than the degree of absorption in the part of the attenuator surrounding said central part.

In general, the central part of the X-ray beam that is emitted by the X-ray source will have a longer path through the object than the part of the X-ray beam around the central portion, whereby X-rays in the fringe area of the X-ray beam may reach the X-ray receiving surface of the X-ray detector without having passed the object. Therefore, the intensity of the X-rays varies over the X-ray receiving surface of the X-ray detector, whereby, in general, the intensity of the received X-rays in the central area is less than the intensity of the received X-rays in the area surrounding the central area, and is much less than the intensity of the received X-rays in the fringe area, especially with imaging of a human head. It has been found out that this variation in intensity of the received X-rays enhances the effect of low frequency drop, in particular in case medium-contrast and low-contrast 3D image reconstructions are made. Furthermore it has been found that reducing said intensity by an attenuator as described above is an effective means for reducing the disturbances in the 3D image caused by said low frequency drop, and it improves the contrast resolution.

In one preferred embodiment, said X-ray detector comprises an X-ray image intensifier. The phenomenon of low frequency drop in an X-ray image intensifier is described in said publication “Origins of flare in X-ray image intensifiers” by R. Luhta and J. A. Rowlands, and is has appeared that by using the attenuator as described above the disturbance of that phenomenon can be considerably reduced.

In another preferred embodiment, said X-ray detector comprises a flat panel X-ray detector. Although the low frequency drop problem in a flat panel X-ray detector is less disturbing then in an X-ray image intensifier, it has appeared that making use of the said attenuator also improves 3D imaging with a flat panel X-ray detector, whereby X-ray scatter may occur within the cover above the scintillator.

Preferably, said attenuator comprises a plate-like member of X-ray absorbing material, which plate-like member has a varying thickness, whereby the central part of the plate-like member is thinner than the area of the plate-like member surrounding said central part. Preferably, there is a gradual transition from the thinner part of the plate-like member in its central area to the thicker part of the plate-like member surrounding that central area. Preferably, the X-ray absorbing material is aluminum, which material has proven to have appropriate physical properties for the purpose.

In one preferred embodiment, one side of the plate-like member of X-ray absorbing material is flat, so that only one side of the plate-like member has to be machined to create the desired differences in thickness of the plate-like member, while the other side can easily be made complete flat and smooth.

In one preferred embodiment, the attenuator is attached to the X-ray tube housing, so that it is integrated in the X-ray source, whereby a flat side of the attenuator is directed towards the X-ray tube.

Furthermore, the invention is related to a method for producing a three-dimensional X-ray image by means of a three-dimensional X-ray imaging device comprising a C-shaped arm that revolves around an axis of rotation through an object to be imaged, whereby an X-ray source is attached to one end of the C-shaped arm, and whereby an X-ray image intensifier for receiving X-rays and intensifying the signals is attached to the other end of the C-shaped arm, whereby an attenuator is installed in front of the X-ray source, which attenuator absorbs a portion of the X-rays, whereby the degree of absorption in the central part of the attenuator is lower than the degree bf absorption in the part of the attenuator surrounding said central part.

The invention will now be further elucidated by means of a description of a three-dimensional X-ray imaging device comprising a C-shaped arm that can revolve around an axis of rotation through an object to be imaged, whereby an X-ray source is attached to one end of the C-shaped arm, and whereby an X-ray image intensifier for receiving X-rays and intensifying the signals is attached to the other end of the C-shaped arm, whereby reference is made to the drawing comprising Figures which are only schematic representations, in which:

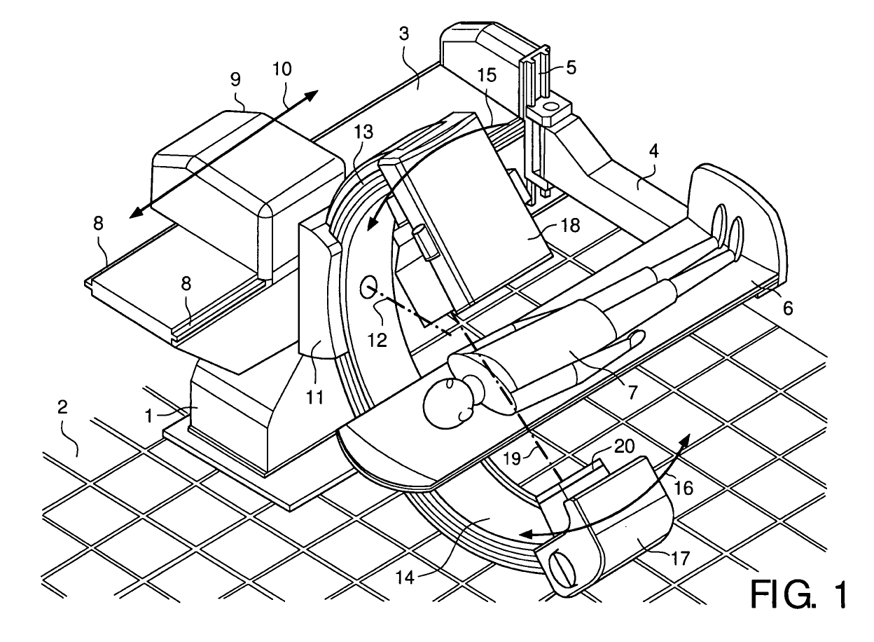

FIG. 1 shows a 3D X-ray imaging device;

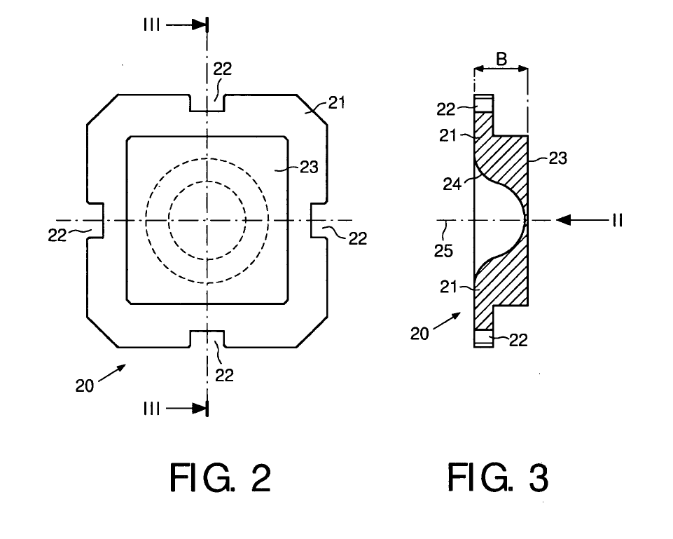

FIG. 2 is a view of an attenuator according to arrow II in FIG. 3; and

FIG. 3 is a sectional view along the line III-III in FIG. 2.

FIG. 1 is a perspective view of a three-dimensional (3D) X-ray imaging device according to the invention, as it is installed in a medical treatment room. A supporting frame 1 is mounted to the floor 2 of the medical treatment room, and comprises a horizontally extending part 3. A horizontal supporting arm 4 is attached to one end of the horizontally extending part 3 through vertical guiding rails 5, so that the supporting arm 4 can be moved up and down in vertical direction. The end of the supporting arm 4 carries a patient table 6 for supporting a patient 7, and a part of that patient 7 has to be imaged.

The horizontal extending part 3 of supporting frame 1 is provided with horizontal extending guiding rails 8, which guiding rails 8 are engaged by sliding frame 9 that can move over said horizontal extending part 3, as is indicated with arrow 10. Rotating frame 11 is attached to sliding frame 9, and rotating frame 11 can revolve with respect to sliding frame 9 around a horizontal axis 12, as is indicated with arrows 15 and 16.

Rotating frame 11 engages circular guiding rails 13 of C-shaped arm 14, so that C-shaped arm 14 can make a revolving motion around an axis which is directed perpendicular to the plane through the C-shaped arm 14, i.e. in FIG. 1 the longitudinal direction of patient table 6.

An X-ray source 17 is attached to the lower end of the C-shaped arm 14, and an X-ray image intensifier 18 is attached to the upper end of the C-shaped arm 14. The X-ray source 17 emits a beam of X-rays in the direction of the X-ray image intensifier 18 as is indicated by the striped line 19. At least a portion of the X-rays passes through the patient 7 lying on the patient table 6, whereby an X-ray image of the interior of a portion of the patient 7 is made by means of the X-ray image intensifier 18. After a number of X-ray images is made, whereby the C-shaped arm 14 is revolving so that the X-rays hit the patient 7 from varying directions, these X-ray images are converted in a known manner into a three dimensional X-ray image reconstruction by means of calculations means in the device, which calculation means are not shown in FIG. 1.

The X-ray source 17 comprises a housing containing the X-ray tube. An X-ray attenuator 20 is attached to that housing, so that the X-rays that are emitted by the X-ray tube pass the attenuator 20 before they leave the X-ray source 17. The attenuator 20 is shown in more detail in the FIGS. 2 and 3.

FIG. 2 shows the plate-like attenuator 20 from the back side, i.e. the side of the attenuator that is directed towards the patient. The attenuator 20 is made of aluminum and in FIG. 3 its total thickness is indicated as B, and is for example 32 mm. The attenuator 20 is provided with a surrounding flange 21 with recesses 22, and can be fixed to the housing of the X-ray source 17 (see FIG. 1) through that flange 21. The attenuator has an outer side 23, which side 23 is flat and is directed towards the patient, and has an outer side 24, which side 24 has substantially a concave surface, in this example a bell-shaped surface, which is rotational symmetric around central axis 25.

When plate-like attenuator 20 is mounted on the X-ray source housing 17 (see FIG. 1) in front of the X-ray tube, the X-ray beam will pass the attenuator 20, whereby a portion of the X-rays will be absorbed by the aluminum material of the attenuator 20. Because the thickness of the material in the central part of the attenuator 20 (near axis 25) is less than the thickness of the material surrounding the central part, the cross section of the X-ray beam will have a distribution of the intensity of the X-rays, whereby the intensity in the central area is higher than the intensity in the area surrounding the central area.

The embodiment as described above is merely an example of a three-dimensional X-ray imaging device comprising an attenuator in front of the X-ray tube; a great many other embodiments are possible.

1. A three-dimensional X-ray imaging device comprising an arm that can revolve around an axis of rotation through an object to be imaged, whereby an X-ray source is attached to one end of the arm, and whereby an X-ray detector for receiving X-rays is attached to the other end of the arm, characterized in that an attenuator is present in front of the X-ray source, which attenuator absorbs a portion of the X-rays, whereby the degree of absorption in the central part of the attenuator is lower than the degree of absorption in the part of the attenuator surrounding said central part.

2. A device as claimed in claim 1, characterized in that said X-ray detector comprises an X-ray image intensifier.

3. A device as claimed in claim 1, characterized in that said X-ray detector comprises a flat panel X-ray detector.

4. A device as claimed in claim 1, characterized in that said attenuator comprises a plate-like member of X-ray absorbing material, which plate-like member has a varying thickness, whereby the central part of the plate-like member is thinner than the area of the plate-like member surrounding said central part.

5. A device as claimed in claim 4, characterized in that the X-ray absorbing material is aluminum.

6. A device as claimed in claim 4, characterized in that one side of the plate-like member of X-ray absorbing material is flat.

7. A device as claimed in claim 1, characterized in that the attenuator is attached to the X-ray tube housing.

8. A method for producing a three-dimensional-X-ray image by means of a three-dimensional X-ray imaging device comprising an arm that revolves around an axis of rotation through an object to be imaged, whereby an X-ray source is attached to one end of the arm, and whereby an X-ray detector for receiving X-rays is attached to the other end of the arm, characterized in that an attenuator is installed in front of the X-ray source, which attenuator absorbs a portion of the X-rays, whereby the degree of absorption in the central part of the attenuator is lower than the degree of absorption in the part of the attenuator surrounding said central part.
